(19) United States
(12) Patent Application Publication
(10) Pub. No.: US 2010/0028252 A1
(43) Pub. Date: Feb. 4, 2010

(54) PROCESSES FOR THE FLUX CALCINATION PRODUCTION OF TITANIUM DIOXIDE

(75) Inventor: Carmine Torardi, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/521,000

(22) PCT Filed: Dec. 26, 2007
(86) PCT No.: PCT/US07/26328

§ 371 Date: Jun. 24, 2009

Related U.S. Application Data
(60) Provisional application No. 60/882,338, filed on Dec. 28, 2006.

(51) Int. Cl. C01G 23/08

(52) U.S. Cl. 423/610

(57) ABSTRACT

Processes for the production of rutile titanium dioxide from titanyl hydroxide using calcination with a flux are provided. Calcination in the presence of sodium chloride flux has been found to lower the calcination temperature used to produce the rutile form of titanium dioxide and to improve control of particle size.

### FIELD OF THE INVENTION

The present invention relates to processes for the production of rutile titanium dioxide from titanyl hydroxide using calcination with a flux. Titanium dioxide, particularly the rutile phase, is used as a white pigment in paints and plastics.

### BACKGROUND

Titanyl hydroxide can be produced by two major processes, chloride and sulfate. Calcination in the presence of sodium chloride flux lowers the calcination temperature used to produce the rutile form of titanium dioxide. Robert (U.S. Pat. No. 5,494,652) discloses a process reacting tin oxide with an alkali metal halide at 400 to 1200° C.

Disclosed herein is a calcination process using a sodium chloride flux for the production of titanium dioxide. The specific parameters of the process produce the rutile phase of titanium dioxide. The process can produce pigmentary-sized rutile.

### SUMMARY OF THE INVENTION

One aspect of the present invention is a process for producing titanium dioxide comprising:
a) mixing sodium chloride with titanyl hydroxide and, optionally, one or more morphology control additives, to form a mixture;
b) heating the mixture to a target temperature of 800 to 1200° C. to form a mixture of titanium dioxide and sodium chloride; and
c) optionally, separating the sodium chloride from the titanium dioxide.

In some embodiments, the heating is carried out over a time period of about 0.5 hours to about 48 hours.

In some embodiments, the mixture is held at the target temperature for up to 72 hours.

### BRIEF DESCRIPTION OF THE FIGURES

FIG. 1 (a) is a scanning electron micrograph of irregularly-shaped particles with a size range of about 50 to 300 nm.

FIG. 1 (b) is a scanning electron micrograph of well-shaped particles with a size range of about 200 to 800 nm, and illustrates how NaCl can serve as a size and shape control agent.

FIG. 2 (a) is a scanning electron micrograph showing media-milled product mainly of 20-100 nm irregularly-shaped particles.

FIG. 2 (b) is a scanning electron micrograph showing media-milled product of well-shaped primary particles in the range of about 100-500 nm.

### DETAILED DESCRIPTION

Flux calcination crystallization using sodium chloride involves conversion of amorphous titanyl hydroxide to the rutile form of titanium dioxide at relatively low temperature conditions (as low as 800° C.) compared to the calcination temperatures without the addition of sodium chloride (ca. 1000° C.) typically utilized in commercial titanium dioxide production. The titanyl hydroxide starting material can be produced by the commercially known sulfate or chloride processes or by other processes. Reaction temperatures in the flux calcination crystallization process range from as low as 800° C. up to 1200° C. Reaction times range from a fraction of a minute to three days. The specific structure-directing flux, sodium chloride, can be used to control the production of the rutile structural form of titanium dioxide. Variation of the range of process conditions such as control of the time at temperature in the reaction mixture can be used to selectively control the resulting titanium dioxide particle size and morphology.

The rutile phase of titanium dioxide of pigmentary size can be formed at 800° C.

In a process of the present invention for the production of rutile titanium dioxide, titanyl hydroxide is mixed with sodium chloride. Titanyl hydroxide can be produced by either of the known commercial processes for titanium dioxide production, the chloride process or the sulfate process. Additionally, titanyl hydroxide can be produced by other known processes such as extraction of titanium-rich solutions from digestion of ilmenite by oxalic acid or hydrogen ammonium oxalate.

After mixing the titanyl hydroxide with sodium chloride, the resulting mixture is heated to a target temperature of 800 to 1200° C. to form titanium dioxide. In preferred embodiments, the heating is carried out over a time period of about 0.5 hours to about 48 hours. In some embodiments, the mixture is held at the target temperature for up 72 hours. The process produces a product comprising titanium dioxide and some of the starting sodium chloride. If desired, the amount of sodium chloride in the product can be reduced by washing or by other separation techniques such as vacuum distillation at about 1000° C.

The concentration of the sodium chloride in the mixture before heating is a factor in controlling the resulting primary particle size and degree of agglomeration and aggregation, i.e., the secondary particle size, of the titanium dioxide obtained from the process. The processes disclosed herein can produce pigmentary-sized titanium dioxide. An average particle diameter of 100 nanometers is usually used to divide nano-sized titanium dioxide from pigmentary-sized titanium dioxide. 100 nanometers is at the low end of the size range of pigmentary titanium dioxide supplied by the existing commercial processes. Smaller particle diameters are referred to as nano-sized titanium dioxide. Pigmentary-sized particles have a large market and thus are frequently the desired particle size. The time at temperature is an important factor in determining the particle size of the resulting titanium dioxide with increasing time at temperature leading to increasing particle size. Titanium dioxide is frequently supplied to the pigment market with a coating such as aluminum which can be added in an additional process step.

### EXAMPLES

### Example 1

This example illustrates the use of NaCl to control the morphology of rutile.

96.0 g ammonium titanyl oxalate (ATO), Aldrich 99.998, were dissolved in 400 mL deionized water and the resulting mixture was filtered to remove undissolved solids. The filtered solution was transferred to a jacketed Pyrex round-bottomed flask equipped with a water-cooled condenser and heated to 90° C. with stirring using a Teflon-coated stirring bar. A solution consisting of 1 part concentrated NH₄OH and 1 part deionized water by volume was added dropwise to the ATO solution until a pH of 7.5 was attained. The white slurry was stirred at 90° C. for 15 minutes after which time it was transferred to a jacketed filter filtered at 90° C. The filter cake was washed several times with water heated to 90° C. until the filtrate had a conductivity of about 500 microSiemens. A small portion of the washed cake was dried in air at room temperature. X-ray powder diffraction showed the dried sample to be nanocrystalline anatase.

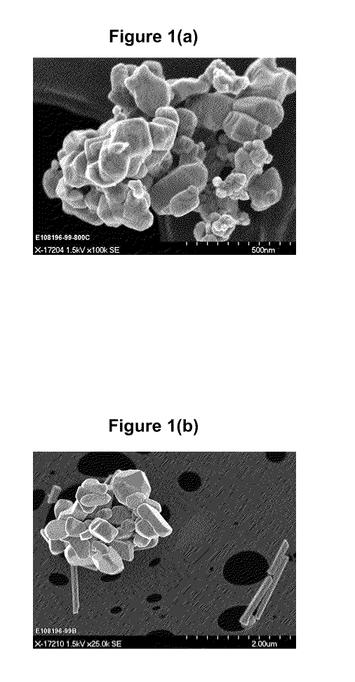

Another portion of dried sample was heated in air from room temperature to 800° C. over a time period of 3 hours, and held at 800° C. for 1 hour. XPD showed the fired product to consist of 99% rutile and 1% anatase. A scanning electron micrograph of this sample (FIG. 1(a)) shows irregularly-shaped particles with a size range of about 50 to 300 nm.

Another portion of dried sample was mixed with NaCl by grinding in a mortar. The amount of NaCl was 5 wt % based on the weight of dry TiO₂. The mixture was heated in air from room temperature to 800° C. over a time period of 3 hours, and held at 800° C. for 1 hour. XPD showed the fired product to consist mainly of rutile with a trace of Na₂Ti₆O₁₃. No anatase was found. A scanning electron micrograph of this sample (FIG. 1 (b) shows well-shaped particles with a size range of about 200 to 800 nm, and illustrates how NaCl can serve as a size and shape control agent.

Another portion dried sample was mixed with NaCl by grinding in a mortar. The amount of NaCl was 5 wt % based on the weight of dry TiO₂. The mixture was heated in air from room temperature to 850° C. over a time period of 3 hours, and held at 850° C. for 1 hour. XPD showed the fired product to consist mainly of rutile with a trace of Na₂Ti₆O₁₃. No anatase was found.

### Example 2

This example illustrates the use of NaCl as a rutile promoter.

2.5 g samples of titanyl hydroxide, derived from an oxalate process leachate and containing about 0.5 g TiO₂ on a dry basis, were heated with NaCl (5 wt % and 33 wt % on TiO₂), and with AlCl₃.6H₂O (1 wt % Al₂O₃ on TiO₂), as described in Table 1 below, in an alumina crucible from room temperature to 90° C. over a 1 hour period and held at 90° C. for 4 hours at which time the temperature was increased to 850° C. over a 3 hour period, and held at 850° C. for 1 hour. Results of X-ray powder diffraction analyses are given in the Table and indicate that NaCl greatly assists the formation of rutile, while in the absence of NaCl, anatase is the predominant product. The results also show addition of aluminum chloride counteracts the sodium chloride and stabilizes anatase.

TABLE 1

| Ingredient | | | | | |
|---|---|---|---|---|---|
| (g) | A | B | C | D | E |
| Ti-ppt | 2.5 | 2.5 | 2.5 | 2.5 | 2.5 |
| NaCl | — | 0.025 | 0.167 | 0.025 | 0.167 |
| AlCl₃•6H₂O | — | — | — | 0.024 | 0.024 |
| H₂O | 1 | 1 | 1 | 1 | 1 |
| Product | anatase | anatase + tr. | ~98% rutile | anatase | anatase |
| | | Na₂Ti₆O₁₃ | ~2% anatase | | |
| | | | tr. Na₂Ti₆O₁₃ | | |
| Ti-ppt | 2.5 | 2.5 | 2.5 | 2.5 | 2.5 |
| NaCl | — | 0.025 | 0.167 | 0.025 | 0.167 |
| AlCl₃•6H₂O | — | — | — | 0.024 | 0.024 |
| H₂O | 1 | 1 | 1 | 1 | 1 |
| Product | anatase | anatase + tr. | ~98% rutile | anatase | anatase |
| | | Na₂Ti₆O₁₃ | ~2% anatase | | |
| | | | tr. Na₂Ti₆O₁₃ | | |

The reaction of Example 2C was repeated without the initial four hour heating at 90° C. and the reaction mixture was heated from room temperature to 850° C. over a 3 hour period and held at 850° C. for 1 hour. From XPD, the product was identified as mainly rutile with traces of anatase and Na₂Ti₆O₁₃.

### Example 3

This example illustrates the use of NaCl as a rutile promoter.

A portion of titanyl hydroxide, derived from an oxalate process leachate, was dried in air at room temperature and used for experiments 3A and 3B (Table 2). 0.6 g samples, containing about 0.5 g TiO₂ on a dry basis, were ground together with NaCl (5 wt % and 33 wt % NaCl based on TiO₂) and heated in alumina crucibles from room temperature to 850° C. over a 3 hour period, and held at 850° C. for 1 hour. Results of X-ray powder diffraction analyses are given in Table 2 and indicate that NaCl greatly assists the formation of rutile.

TABLE 2

| Ingredient (g) | 3A | 3B |
|---|---|---|
| Ti-ppt (g) | 0.6 | 0.6 |
| NaCl (g) | 0.025 | 0.167 |
| Product | ~1:1 rutile:anatase | Essentially all rutile with tr. |
| | Trace Na₂Ti₆O₁₃ | Na₂Ti₆O₁₃ |

### Example 4

This example shows that NaCl is a rutile promoter when particle size control additives used in the sulfate process are also present.

A portion of titanyl hydroxide, derived from an oxalate process leachate, was dried in air at room temperature and used for experiments Example 4A and Example 4B. 0.6 g samples, containing about 0.5 g TiO₂ on a dry basis, were ground together with 0.0005 g Na₂SO₄, 0.0025 g K₂SO₄, 0.0024 g, NH₄H₂PO₄, and 0.025 g rutile seed. 0.025 g NaCl (5 wt %) were added to sample B and both samples were heated in alumina crucibles from room temperature to 800° C. over a 3 hour period, and held at 800° C. for 1 hour. Results of X-ray powder diffraction analyses are given in Table 3 and indicate that NaCl greatly assists the formation of rutile.

TABLE 3

| | Example 4 A | Example 4 B |
|---|---|---|
| Product: | Mainly anatase with | ~60% rutile, 40% anatase |
| | v. small amount rutile | |

### Example 5

This example illustrates the use of NaCl to control the morphology of rutile.

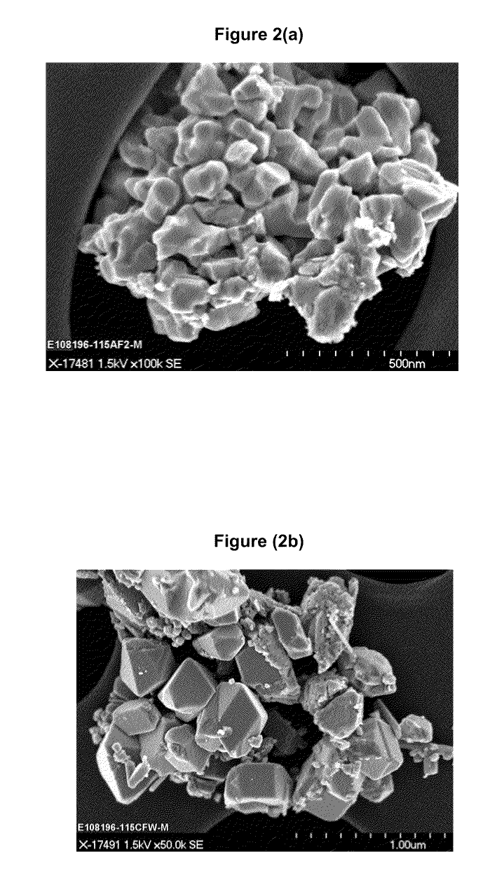

36.8 g ammonium titanyl oxalate (ATO), Aldrich 99.998, were dissolved in 300 mL deionized water and the resulting mixture was filtered to remove undissolved solids. The filtered solution was transferred to a Pyrex beaker and stirred with a Teflon-coated stirring bar. Concentrated NH₄OH was added dropwise to the ATO solution until a pH of 9 was attained. The white slurry was filtered immediately and the filter cake was washed with 400 mL deionized water at room temperature. The Ti-containing cake was transferred to a beaker and 450 mL concentrated NH₄OH were added and the mixture was stirred and boiled for 30 minutes. The precipitate filtered rapidly. The Ti cake was again transferred to a beaker and reslurried with concentrated NH₄OH, then boiled for 30 minutes. After collecting the solids on a filter, the cake was transferred to a beaker, slurried with about 450 mL deionized water, stirred for one day at room temperature, then boiled for one hour. After collecting the solids, the washed cake was dried in air under IR heat (˜40 C). The entire sample was heated to 800° C. over a period of three hours, and held at 800° C. for three hours. An X-ray powder diffraction pattern of the fired product showed it to be mainly rutile with a trace of anatase. Scanning electron microscopy imaging showed media-milled product to consist mainly of 20-100 nm irregularly-shaped particles as shown in FIG. 2(a).

Ti-precipitate cake was made as described above, but before drying the washed cake under IR heat, 3.32 g NaCl, dissolved in 10 mL H₂O, were mixed into the TiO₂ cake. The entire sample was heated to 800° C. over a period of three hours, and held at 800° C. for one hour. An X-ray powder diffraction pattern of the fired product showed it to be 95% rutile and 5% anatase. Scanning electron microscopy imaging showed media-milled product to consist of well-shaped primary particles in the range of about 100-500 nm and some small, <100 nm, irregularly-shaped particles as shown in FIG. 2(b).

### Example 6

This example shows that NaCl is a rutile promoter when particle size control additives used in the sulfate process are also present, and when the mixture is heated in a rotary calciner.

315 g of titanyl hydroxide, derived from an oxalate process leachate, containing ˜49 g TiO₂ on a dry basis, was mixed with 49 g of a solution consisting of 0.19 wt % KH₂PO₄, 0.38 wt % K₂HPO₄, and 0.09 wt % Na₂HPO₄ in H₂O, 98 g of a solution consisting of 2.4 wt % AlCl₃.6H₂O in H₂O, 49 g of a solution consisting of 4.8 wt % NaCl in H₂O, and 69 g of 2.9 wt % rutile seed suspension in aqueous HCl solution. The mixture was dried in air under IR heat (˜40° C.) and powdered in a mortar. 55 g of the dried mixture were heated to 1050° C. in a fused silica rotary calciner over a period of 3 hours and held at 1050° C. for 8 hours. An XPD pattern of the product showed it to be all rutile.

2.5 g of the dried mixture prepared as described above were fired in an alumina crucible to 1050° C. over a 12 hour period at which point power to the furnace was removed and the sample was allowed to cool naturally to room temperature. An XPD pattern of the product showed it to be rutile with a trace of Na₂Ti₆O₁₃.

2.5 g of the dried mixture prepared as described above were fired in an alumina crucible to 1150° C. over a 12 hour period at which point power to the furnace was removed and the sample was allowed to cool naturally to room temperature. An XPD pattern of the product showed it to be all rutile.

### Example 7

Titanyl hydroxide, derived from an oxalate process leachate, was washed with water at room temperature to remove NH₄OH via cycles of stirring and centrifuging until the pH was about 7-8. The slurry used for the experiments contained 13.18 wt % TiO₂ as shown in Table 4. Phosphate, potassium and sodium additives were mixed with the titanyl hydroxide as indicated in Table 4. Sodium chloride flux was added to some of the mixtures. When sodium chloride was present, a greater amount of rutile was observed at the lower target temperatures, showing that NaCl is a good rutile promoter. SEM images showed that NaCl was a particle morphology control agent at 800° C.

TABLE 4

| g of Washed | | | | | Ramp-up | | | | |
|---|---|---|---|---|---|---|---|---|---|
| Oxalate Process | g of 0.48 | g of 0.43 | g of 0.07 | g of 3.0 | time (hrs) | | Hold Time | | |
| Leachate Ti-ppt., | wt % H3PO4 | wt % KCl | wt % NaCl | wt % NaCl | to Target | Target | (hrs) at | | |
| 13.2 wt % TiO2 | Solution | Solution | Solution | Solution | Temp | Temp ° C. | Target Temp | % Rutile | % Anatase |
| 15.2 | 1 | 3 | 1 | 2 | 5 | 1050 | 4 | 100 | 0 |
| 15.2 | 3 | 1 | 3 | 0 | 5 | 1050 | 4 | 99 | 0 |
| 15.2 | 1 | 3 | 3 | 2 | 5 | 850 | 0 | 60 | 40 |
| 15.2 | 3 | 1 | 1 | 0 | 5 | 850 | 0 | 0 | 100 |
| 15.2 | 3 | 1 | 3 | 2 | 5 | 1050 | 0 | 100 | 0 |
| 15.2 | 1 | 3 | 1 | 0 | 5 | 1050 | 0 | 96 | 4 |
| 15.2 | 1 | 1 | 1 | 2 | 15 | 1050 | 0 | 100 | 0 |
| 15.2 | 3 | 3 | 3 | 0 | 15 | 1050 | 0 | 100 | 0 |
| 15.2 | 3 | 1 | 1 | 2 | 5 | 850 | 4 | 99 | 1 |
| 15.2 | 1 | 3 | 3 | 0 | 5 | 850 | 4 | 4 | 96 |
| 15.2 | 1 | 1 | 3 | 0 | 15 | 850 | 0 | 0.5 | 99.5 |
| 15.2 | 3 | 3 | 1 | 2 | 15 | 850 | 0 | 100 | 0 |
| 15.2 | 3 | 3 | 3 | 2 | 15 | 1050 | 4 | 100 | 0 |
| 15.2 | 1 | 1 | 1 | 0 | 15 | 1050 | 4 | 100 | 0 |
| 15.2 | 1 | 1 | 3 | 2 | 15 | 850 | 4 | 100 | 0 |
| 15.2 | 3 | 3 | 1 | 0 | 15 | 850 | 4 | 3 | 97 |
| 15.2 | 1 | 0 | 3 | 0 | 15 | 800 | 0 | 0 | 100 |
| 15.2 | 1 | 1 | 3 | 3.33 | 15 | 800 | 0 | 12 | 88 |
| 15.2 | 1 | 0 | 3 | 3.33 | 15 | 850 | 0 | 100 | 0 |
| 15.2 | 1 | 0 | 3 | 0 | 15 | 800 | 0 | 0 | 100 |
| 15.2 | 1 | 1 | 3 | 3.33 | 16 | 800 | 4 | 100 | 0 |

What is claimed:

1. A process for producing titanium dioxide comprising:
a) mixing sodium chloride with titanyl hydroxide and, optionally, one or more morphology control additives, to form a mixture;
b) heating the mixture to a target temperature of 800 to 1200° C. to form a mixture of titanium dioxide and sodium chloride; and
c) optionally, separating the sodium chloride from the titanium dioxide.

2. The process of claim 1 wherein the heating is carried out over a time period of about 0.5 hours to about 48 hours.

3. The process of claim 1 wherein the mixture is held at the target temperature for up to 72 hours.

4. The process of claim 1 wherein the amount of sodium chloride is from 1 wt % to 50 wt % based on the amount of titanium dioxide that can be recovered from the titanyl hydroxide.

5. The process of claim 1 wherein the amount of sodium chloride is from 1 wt % to 30 wt % based on the amount of titanium dioxide that can be recovered from the titanyl hydroxide.

6. The process of claim 1 wherein the amount of sodium chloride is from 1 wt % to 10 wt % based on the amount of titanium dioxide that can be recovered from the titanyl hydroxide.

7. The process of claim 1 wherein the sodium chloride is in solid form.

8. The process of claim 1 wherein the sodium chloride is in solution.

9. The process of claim 1 wherein the mixing comprises stirring, shaking, or tumbling for several minutes up to several days.

10. The process of claim 1 wherein the morphology control additives contain ions selected from the group consisting of phosphate, potassium, sodium, and aluminum.

11. The process of claim 1 wherein the titanyl hydroxide is produced from titanyl sulfate solution.

12. The process of claim 1 wherein the titanyl hydroxide is produced from titanium oxychloride solution.

13. The process of claim 1 wherein the titanyl hydroxide is produced from ammonium titanyl oxalate solution.

14. The process of claim 1 wherein the heating is performed in a rotary calciner.

15. The process of claim 1 wherein the heating is performed in a static calciner.

16. The process of claim 1 wherein the sodium chloride is separated from the titanium dioxide by water washing.

17. The process of claim 1 wherein the sodium chloride is separated from the titanium dioxide by vacuum distillation.

18. The process of claim 1 wherein the titanium dioxide comprises the rutile form.

19. The process of claim 18 wherein the rutile titanium dioxide has a particle size of 50 to 1000 nm.

20. The process of claim 18 wherein the rutile titanium dioxide has a particle size of 50 to 500 nm.

21. The process of claim 1 wherein the mixture is heated to a temperature of 800-1000° C.

22. The process of claim 1 wherein the mixture is heated to a temperature of 800-900° C.

23. The process of claim 1 wherein the target temperature is reached within a time period of 0.5 to 48 hours.

24. The process of claim 1 wherein the target temperature is reached within a time period of 1 to 24 hours.

25. The process of claim 1 wherein the mixture is held at the target temperature for up to 72 hours.

26. The process of claim 1 wherein the mixture is held at the target temperature for up to 48 hours.

27. The process of claim 1 wherein the mixture is held at the target temperature for up to 24 hours.
